(19) United States
(12) Patent Application Publication
(10) Pub. No.: US 2013/0346158 A1
(43) Pub. Date: Dec. 26, 2013

(54) METHOD FOR DRIVERS OF MOTOR VEHICLES OR MOTOR BOATS TO LOCK IN THE PRICE THEY PAY FOR FUEL IRRESPECTIVE OF THE QUANTITY OF FUEL THEY USE IN THE FUTURE

(71) Applicants: Steven Jay Wolf, North Miami Beach, FL (US); Jeremy Zeev Gelbart, Far Rockaway, NY (US)

(72) Inventors: Steven Jay Wolf, North Miami Beach, FL (US); Jeremy Zeev Gelbart, Far Rockaway, NY (US)

(21) Appl. No.: 13/923,797

(22) Filed: Jun. 21, 2013

Related U.S. Application Data
(60) Provisional application No. 61/662,459, filed on Jun. 21, 2012.

(51) Int. Cl. G06Q 30/02

(52) U.S. Cl. CPC G06Q 30/0206
USPC 705/7.35

(57) ABSTRACT

Using a monitoring system to track fuel consumption and a computer to record the fuel consumption data, a hedging company can let its customers lock in the price of fuel and not the quantity or the delivery schedule because the hedging company has expertise in knowing the customers usage of the motor vehicle, including knowing the expected quantity and schedule of the fuel consumption, and can guarantee the price a customer pays for the fuel based in part on the customer's usage. For example, irrespective of if the customer actually uses 500 gallons of fuel or 1000 gallons of fuel, the price per gallon will be guaranteed to be ‘X’ dollars. ‘X’ being the price that the customer and the hedging company agree to.

### CROSS-REFERENCE TO RELATED APPLICATIONS

This application claims the benefit of provisional patent application Ser. No. 61/662,459, filed Jun. 21, 2012, the entire contents of which are incorporated herein in their entirety.

### BACKGROUND

When people purchase motor vehicles, they try to determine the expected fuel costs based on their expected usage. However, this is almost impossible for the average driver, because, in order to do so, he would need to determine his expected fuel consumption and the future prices of fuel.

The average driver cannot accurately predict his expected fuel consumption, and even if the he could, he still wouldn't be able to estimate his expected fuel costs because he is not an expert in the oil markets and cannot predict the future price of the fuel.

Therefore, if possible, the average driver should lock in the price of fuel without locking in a specified quantity and delivery schedule. Up to this point, this was impossible for the average driver. Our invention addresses this issue.

### SUMMARY

Using a monitoring system to track fuel consumption and a computer to record the fuel consumption data, a hedging company can let its customers lock in the price of fuel and not the quantity or the delivery schedule because the hedging company has expertise in knowing the customers usage of the motor vehicle, including knowing the expected quantity and schedule of the fuel consumption, and can guarantee the price a customer pays for the fuel based in part on the customer's usage. For example, irrespective of if the customer actually uses 500 gallons of fuel or 1000 gallons of fuel, the price per gallon will be guaranteed to be ‘X’ dollars. ‘X’ being the price that the customer and the hedging company agree to.

Using the same method, a hedging company can also lock in the price for other fuel-consuming products including but not limited to motorboats.

This service is not limited to consumers and can also be applied to businesses.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 is an overview and illustrates how all the different parties, the customer's car 60-62, gas station 50-52, credit card company 54, and hedging company 55-59, all communicate through an Intranet, the Internet, LAN or VPN 53.

FIG. 2 illustrates the system for gathering information on a customer to make a prediction about the customer's future fuel usage

FIG. 3 is a flow chart illustrating the steps of a first embodiment of the present invention.

FIG. 4 is a flow chart illustrating the steps of a second embodiment of the present invention.

### DESCRIPTION OF THE PREFERRED EMBODIMENTS

Reference will now be made in detail to the preferred embodiments of the present invention, examples of which are illustrated in the accompanying drawings

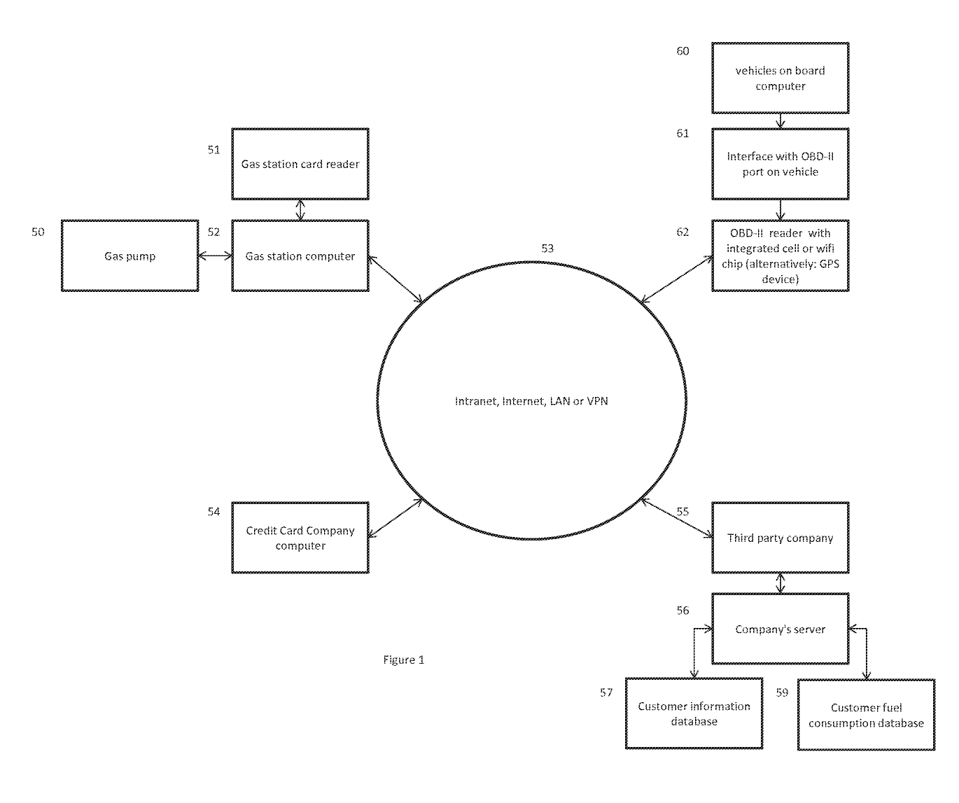

FIG. 1 is a flowchart illustrating an overview of the present invention. As illustrated in FIG. 1, 50 the customer provides a credit card as a method of payment at a gas station. The gas station accepts the customer's credit card information as a method of payment for the customer's fuel purchase through a process of pre-approval 51 using a credit card reader or any other method known to those who are experts in the field. The gas station 52 dispenses fuel to the customer. After dispensing fuel to the customer, the gas station transmits 53 the customer's credit card information to the credit card company via 53 Intranet, Internet, LAN or VPN. The credit card company 54 forwards the customer's transaction information via 53 Intranet, Internet, LAN or VPN to the hedging company and the hedging company 55 receives the customer's transaction information and 56 inputs the customer's transaction information in a 57 database on the 56 hedging company's server.

Upon receiving the customer's transaction information, the hedging company queries the customer information 57 database to retrieve the customer's locked in price and software on the hedging company's server 56 calculates the difference between the customer's locked in price and the actual price of fuel. The hedging company's server 56 transmits the customer's locked in price to the credit card company via 53 Intranet, Internet, LAN or VPN. Money is then transferred between 55 the hedging company and 54 credit card company to rectify the difference between the customer's locked in price and the actual price of the fuel. 54 The credit card company then adjusts the customer's bill to reflect the locked in price agreed upon by the customer and the hedging company.

The hedging company may also monitor the customer's fuel consumption by connecting 61 a plug and play monitoring device such as an 62 OBD-II device with a cellular or WiFi modem and integrated GPS technology to a vehicle's OBD port thereby connecting to the 60 vehicle's internal computer. Such a device has the capability to directly monitor and communicate vital vehicle information via 53 Intranet, Internet, LAN or VPN.

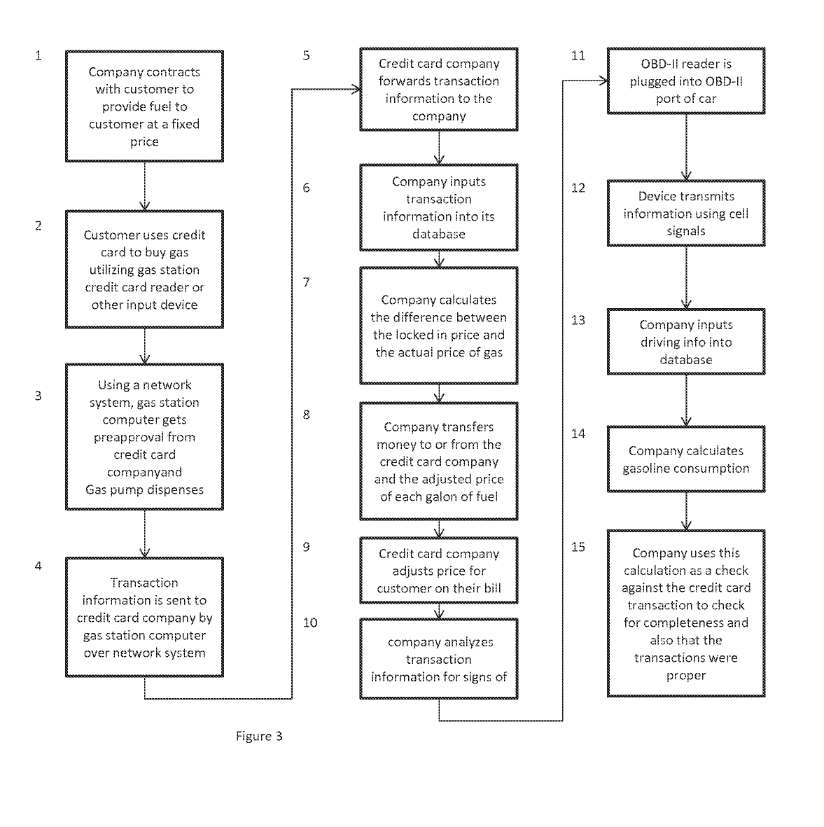

FIG. 3 is a flowchart illustrating the steps of a first embodiment of the present invention. As illustrated in FIG. 3, A hedging company makes a contract with a customer to provide fuel for a particular vehicle at a fixed price. As a further embodiment, the contract imposes minimum and maximum limits to the quantity of fuel protected against fuel price fluctuation. By imposing these contractual limitations regarding the quantity of fuel protected against fuel price fluctuation, the hedging company minimizes its exposure to risks associated with extraordinary fuel consumption and with customers utilizing the hedging company's services to speculate on commodity prices. The intent of these contractual limitations is to narrow the hedging company's customer base to those customers who engage the hedging company's services with the sole intention of protecting their day-to-day fuel consumption from price fluctuation. This will help the hedging company avoid taking on risks that will skew the risk pool. As an example, if a customer who is a normal retail automobile user, uses, 2000 gallons of gas in a year (this representing an estimated 30,000 miles a year), the hedging company will only lock in the price of gas for 1,000 gallons (representing 15,000 miles). As another example, if a customer who is a normal retail automobile user uses 50 gallons (representing, 750 miles driven) the hedging company will treat the customer as if they used 500 gallons (representing, 7,500 miles driven). In this example, the hedging company will multiply the amount of gas not used under the contract by the difference of the average actual price during that time period minus the agreed upon locked in price of the fuel. The minimums and maximum amounts of fuel will be a part of the contract terms with the customer.

23, 1 the customer provides a credit card as a method of payment at a gas station. The gas station accepts the customer's credit card information as a method of payment for the customer's fuel purchase through a process of pre-approval 2 using a credit card reader or any other method known to those who are experts in the field. The gas station 3 dispenses fuel to the customer. After dispensing fuel to the customer, the gas station transmits 4 the customer's credit card information to the credit card company. As another embodiment, the credit card company could be the one offering the fuel price protection contract.

The credit card company 5 forwards the customer's transaction information to the hedging company and the hedging company receives the customer's transaction information and 6 inputs the customer's transaction information in a database on the network system.

Upon receiving the customer's transaction information, 7 the hedging company calculates the difference between the customer's locked in price and the actual price of fuel. The hedging company 8 transmits the customer's locked in price to the credit card company. Money is then transferred between the hedging company and the credit card company to rectify the difference between the customer's locked in price and the actual price of the fuel. The credit card company then 9 adjusts the customer's bill to reflect the locked in price agreed upon by the customer and the hedging company.

Accessing the network system, the hedging company can 10 retrieve transaction records from the database and analyze the transactions to detect fraud on the part of the customer. The transaction records may include the location of transactions, the date of transactions, and the quantity of fuel purchased in transactions, and other data that may accompany these transactions.

A further element of this embodiment includes connecting a plug and play monitoring device such as a 11 OBD-II device with a cellular or WiFi modem and integrated GPS technology to a vehicle's OBD port. Such as device has the capability to directly monitor and communicate vital vehicle information. With an integrated OBDII interface, the device can monitor vehicle location, speed, VIN, ignition status, Diagnostic Fault Codes (DFCs/DTCs) among other parameters available through the OBD port. An OBD device can be installed in a matter of seconds by anyone without tools or manuals.

During normal operation, a vehicle is constantly monitoring standard Parameter ID (PID) codes. Every vehicle is capable of transmitting these codes over its OBD-II connection. These codes provide information on a vehicle's emissions system such as fuel system status, engine data, and vehicle speed. The vehicle's computer is able to send this information over the OBD-II connection to a connected device through Parameter ID (PID) codes. Armed with vehicle data available through the OBD-II connection, including data such as mass air-flow and vehicle speed, one can derive vehicle fuel consumption. There are other methods known to those who are experts in the field for deriving vehicle fuel consumption through OBD-II data.

There are other embodiments of such monitoring devices that can connect to a vehicle's internal computer system and monitor and communicates vital vehicle information known to those who are experts in the field. The device would 12 transmit the information back to the hedging company using cellular technology, Wi-Fi or any other wireless technology. There are other methodologies of retrieving the information that are known to those knowledgeable in the field. The hedging company then 13 inputs, analyzes, and stores all the customer's driving information in a database. 14 Hedging company calculates fuel consumption from driving information. 15 Hedging company uses this calculation as a check against the credit card transaction to check for completeness and also that the transactions were proper. 16 If there is a discrepancy, the hedging company resolves issue with the credit card company or goes directly to the customer.

This embodiment of tracking a customer's fuel purchases through the usage of a credit card, or another similar device that is obvious to those in the field, will help to improve the customer's experience by allowing the hedging company to adjust the price of the fuel automatically for the customer. Furthermore, using a credit card payment system can also be an additional source of revenue for the hedging company because the hedging company will make money on the purchases that are made with the credit card, just like all other credit card issuers.

A monitoring device is important because if the hedging company that is providing the service of locking in a customer's fuel prices doesn't know how much fuel the customer's vehicle is actually using, then it's possible that the customer will purchase more fuel for other vehicles when the price of fuel is above the price that he locked it in for and he or she will conceal his or hers purchases of fuel when the price is lower than the price he or she locked it in for.

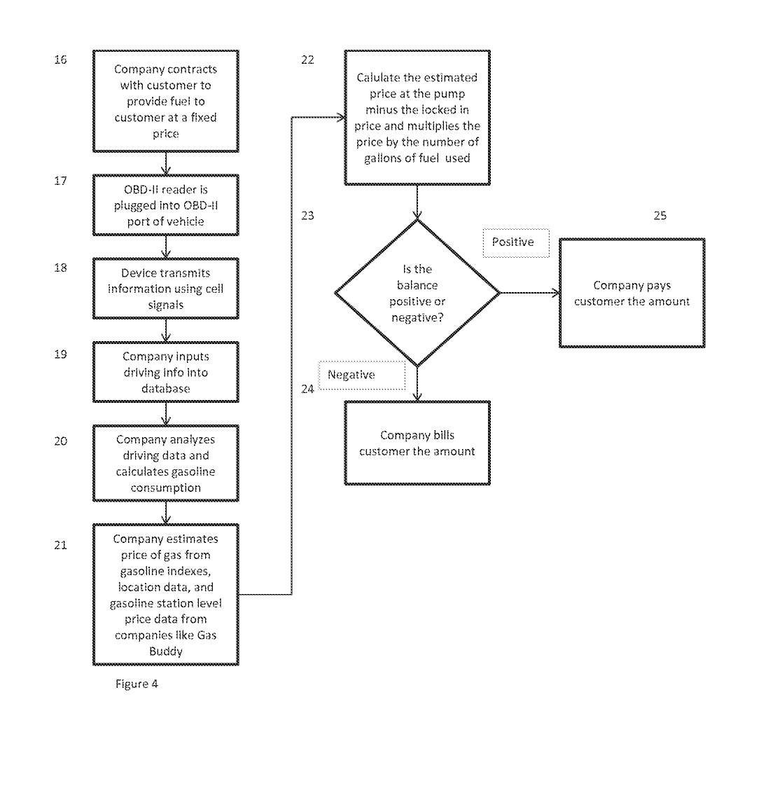

FIG. 4 is a flowchart illustrating the steps of a second embodiment of the present invention. As illustrated in FIG. 4, a monitoring device comprising hardware and software is connected to the internal computer system of a vehicle. An example of this would be an 17 OBD-II reader but there are other embodiments for connecting to the internal computer system of a vehicle that are obvious to those who are experts the field. The device would 18 transmit the information back to the hedging company using cellular technology, Wi-Fi or any other wireless technology. There are other methodologies of retrieving the information that are obvious to those knowledgeable in the field. The hedging company then 19 inputs, analyzes, and stores all the customer's driving information in a database. 20 Hedging company calculates fuel consumption from driving information. 21 Hedging company estimates price of fuel from fuel indexes, location data, and gasoline station level price data from companies such as Gas Buddy. 22 The hedging company calculates the difference between the estimated price at the pump and the locked in price and multiples the difference by the number of gallons of fuel to determine 23 the amount of money that the 24 hedging company owes the customer. 25 If it is a negative amount then the customer owes the hedging company.

An alternative to an OBD-II reader that connects to a vehicle's internal computer system as described in FIGS. 3-11 and FIGS. 4-17 is to install a device on the customer's vehicle that monitors the vehicle's location. Fuel consumption can be estimated using vehicle location data. An example of a location monitoring device is a GPS monitoring device. However, there are other devices that are obvious to those in the field.

The hedging company's contracts with customers will also limit our exposure from risks associated with extraordinary fuel consumption or customers who want to use our services to speculate on commodity prices. By imposing minimum and maximum limits to the quantity of fuel protected against fuel price fluctuation, the hedging company's contractual obligations will be narrowed to customers who engage our services with the intent of protecting their day-to-day fuel consumption from price fluctuation and not for other purposes. This will help the hedging company avoid taking on risks that will skew the risk pool.

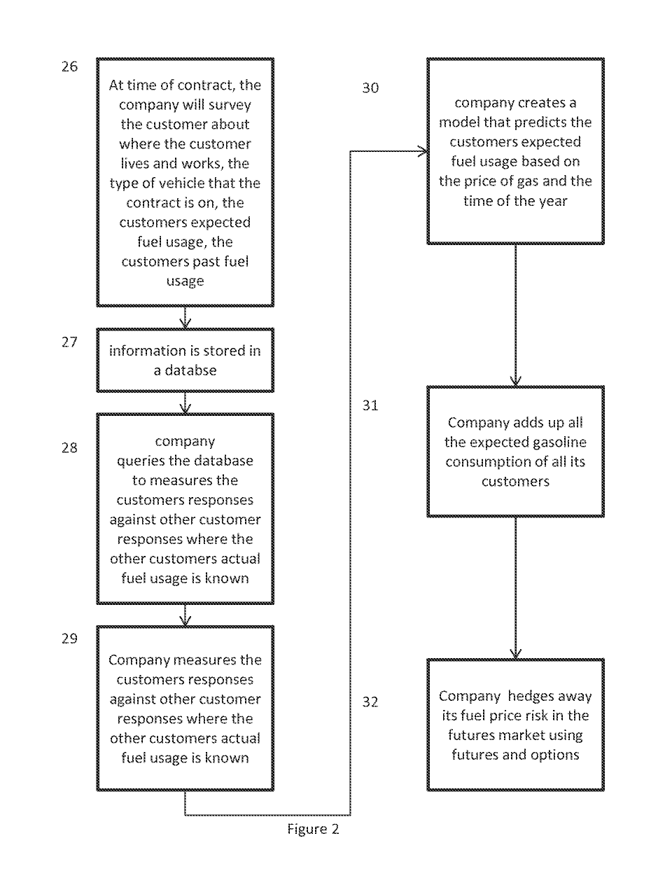

As another embodiment, FIG. 2, at the time 1 & 16 the customer creates the contract with the hedging company, the hedging company will survey 26 the customer about where the customer lives and works, the type of vehicle that the contract is on, the customers expected fuel usage, the customers past fuel usage and other questions that are obvious to those who are experts in the field and stores 27 this information in a database. Then the hedging company creates a 30 model about the customers expected fuel usage based on the price of the fuel, the time of the year and other factors that are obvious to those who are experts in the field by querying 28 the database to measure the customer's responses 29 against other customer responses where the other customers actual fuel usage is known. The computer then predicts the amount of fuel the customer will use. Then the hedging company adds 31 up all the expected fuel consumption of all its customers and hedges 32 away its fuel price risk in the futures market using futures and options.

We claim:

1. A method for end users of a vehicle to fix the price they pay for fuel comprising:
A) forming a contract between end users of a vehicle and a hedging company for a variable quantity and varying delivery schedule of fuel based on the fuel consumption of the vehicle;
B) fueling the vehicle using fuel purchased using a price set in the contract;
C) monitoring fuel consumption of the vehicle using a monitoring device;
D) transmitting fuel consumption data from the monitoring device to the hedging company; and
E) recording the fuel consumption of the vehicle in a computer system.

2. The method according to claim 1, wherein the end user is a consumer.

3. The method according to claim 1, wherein the vehicle is an automobile, boat, or a motorcycle.

4. The method according to claim 1, wherein a credit card or a debit card is used in fueling the vehicle.

5. The method according to claim 1, wherein the monitoring device transmits the fuel consumption data using Wi-Fi or cellular communication.

6. The method according to claim 1, further comprising:
the hedging company surveying the end user to gather personal information about a work location of the end users, a home address of the end users, expected fuel usage of the vehicle, past fuel consumption data of the vehicle;
storing the personal information in a customer profile in a database;
using a prediction model to predict future fuel consumption of the vehicle by comparing the customer profile to other customer profiles stored in the database, wherein the other customer profiles have stored therein past fuel consumption data; and
wherein the price of the fuel in the contract is set based upon the comparison.

7. A system to predict the fuel consumption of a vehicle of a customer comprising:
A) a hedging company, wherein the hedging company surveys the customer to gather a customer profile comprising a home address of a customer, a work address of a customer, a type of the vehicle, an expected fuel consumption, and past fuel consumption data;
B) a database that stores the customer profile;
wherein the hedging company utilizes a prediction model to predict future fuel consumption of the vehicle by comparing the customer profile to other customer profiles stored in the database, wherein the other customer profiles have stored therein past fuel consumption data; and
wherein the hedging company sets a price of fuel for the customer based upon the results of the comparison.

8. The system according to claim 7, wherein the vehicle is an automobile, a boat, or a motorcycle.
